(19) United States
(12) Patent Application Publication
(10) Pub. No.: US 2017/0214598 A1
(43) Pub. Date: Jul. 27, 2017

(54) TEST DEVICE, NETWORK SYSTEM, AND TEST METHOD

(71) Applicant: FUJITSU LIMITED, Kawasaki-shi (JP)

(72) Inventor: Shinya KANO, lnagi (JP)

(73) Assignee: FUJITSU LIMITED, Kawasaki-shi (JP)

(21) Appl. No.: 15/361,915

(22) Filed: Nov. 28, 2016

(30) Foreign Application Priority Data
Jan. 27, 2016 (JP) 2016-013818

(51) Int. Cl. H04L 12/26; H04L 29/08; H04L 12/24

(52) U.S. Cl. CPC H04L 43/50; H04L 43/08; H04L 41/24; H04L 41/30; H04L 67/1034; H04L 41/145

(57) ABSTRACT

A test device includes a memory and a processor coupled to the memory. The processor is configured to perform a simulation of a first test to be executed on a network that is in operation. The processor is configured to acquire a first quality. The first quality is a quality of a communication service provided by the network when the simulation is performed. The processor is configured to determine, on basis of the first quality, whether to execute the first test. The processor is configured to execute the first test on the network depending on a result of the determination.

### CROSS-REFERENCE TO RELATED APPLICATION

This application is based upon and claims the benefit of priority of the prior Japanese Patent Application No. 2016-013818, filed on Jan. 27, 2016, the entire contents of which are incorporated herein by reference.

### FIELD

The embodiment discussed herein is related to a test device, a network system, and a test method.

### BACKGROUND

With the spread of server virtualization technology and network virtualization technology, networks have been complicated. The server virtualization technology is a technology in which a plurality of computers are virtually formed in a single server, and an individual operating system (OS) and applications are implemented in the respective virtual computers. The network virtualization technology is a technology in which various network functions are virtually formed in a server or the like using applications.

Furthermore, for example, use of open source software (OSS), linkage between new and old systems, or the like, is desired to be employed, networks are even more complicated. When a network is complicated, a potential problem may arise while the network is in operation and influence a communication service that is being provided on the network. This problem is not limited to the virtual machine (VM) described above, but may similarly arise in a physical server and a physical communication device such as a transmission device.

To cope with this problem, software that executes, for example, an automatic test of inputting test traffic, generating a pseudo failure, or the like has been studied and developed. Examples of such software include, for example, “Chaos Monkey”, which Netflix (registered trademark) Inc. plays a central role to develop. Using “Chaos Monkey”, a virtual machine that is a test target may be selected at random from a virtual machine group registered on a cloud, stop of the virtual machine or the like may be forcibly executed, and the performance of restoration from a failure may be tested.

Note that, regarding a test, a method for performing failure diagnosis of a plurality of central processing units (CPUs) has been proposed.

Related technique is disclosed in, for example, International Publication Pamphlet No. WO2011-141992.

However, when a test is executed on a network that is in operation, an influence on the quality of a communication service that is being provided on the network is a concern. For example, in a network that is in operation, assuming that there are three virtual firewalls between which a load is distributed by a virtual load balancer, when a test in which a failure is artificially caused to occur in one of the virtual firewalls is performed, the other two of the virtual firewalls are operated in a degenerate mode due to the pseudo failure and the entire traffic processing performance is reduced to two-thirds to thus reduce a throughput, so that the quality of the communication service is reduced.

Also, assuming that the above-described three virtual firewalls process traffic at 90% of the maximum traffic processing performance, when test traffic of 10% or more of the above-described traffic amount is input, the entire traffic amount exceeds the traffic processing performance of the three virtual firewalls. Thus, the three virtual firewalls are no longer able to process traffic, and discard or delay of traffic occurs, so that the quality of the communication service is reduced.

### SUMMARY

According to an aspect of the present invention, provided is a test device including a memory and a processor coupled to the memory. The processor is configured to perform a simulation of a first test to be executed on a network that is in operation. The processor is configured to acquire a first quality. The first quality is a quality of a communication service provided by the network when the simulation is performed. The processor is configured to determine, on basis of the first quality, whether to execute the first test. The processor is configured to execute the first test on the network depending on a result of the determination.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary configuration of a network system;

FIG. 2 is a diagram illustrating an exemplary configuration of a test execution server;

FIG. 3 is a diagram illustrating an example of redundant configuration definition information;

FIG. 4 is a flowchart illustrating a first example of processing performed by a test execution server;

FIG. 5 is a flowchart illustrating a first example of service quality prediction processing;

FIG. 6 is a diagram illustrating an exemplary configuration of network function sections;

FIG. 7 is a diagram illustrating an example of a topology of a network function section for use in path calculation;

FIG. 8 is a diagram illustrating an example of a topology when a network function section with a failure is removed;

FIG. 9 is a diagram illustrating a method for calculating a transferable traffic band of each path;

FIG. 10 is a diagram illustrating a method for calculating a transferable traffic band of each path;

FIG. 11 is a diagram illustrating a method for calculating a transferable traffic band of each path;

FIG. 12 is a diagram illustrating a method for calculating a transferable traffic band of each path;

FIG. 13 is a flowchart illustrating a second example of processing performed by a test execution server;

FIG. 14 is a flowchart illustrating a second example of service quality prediction processing; and

FIG. 15 is a diagram illustrating an example of a method for calculating a transferable traffic band of a group of a network function section.

### DESCRIPTION OF EMBODIMENT

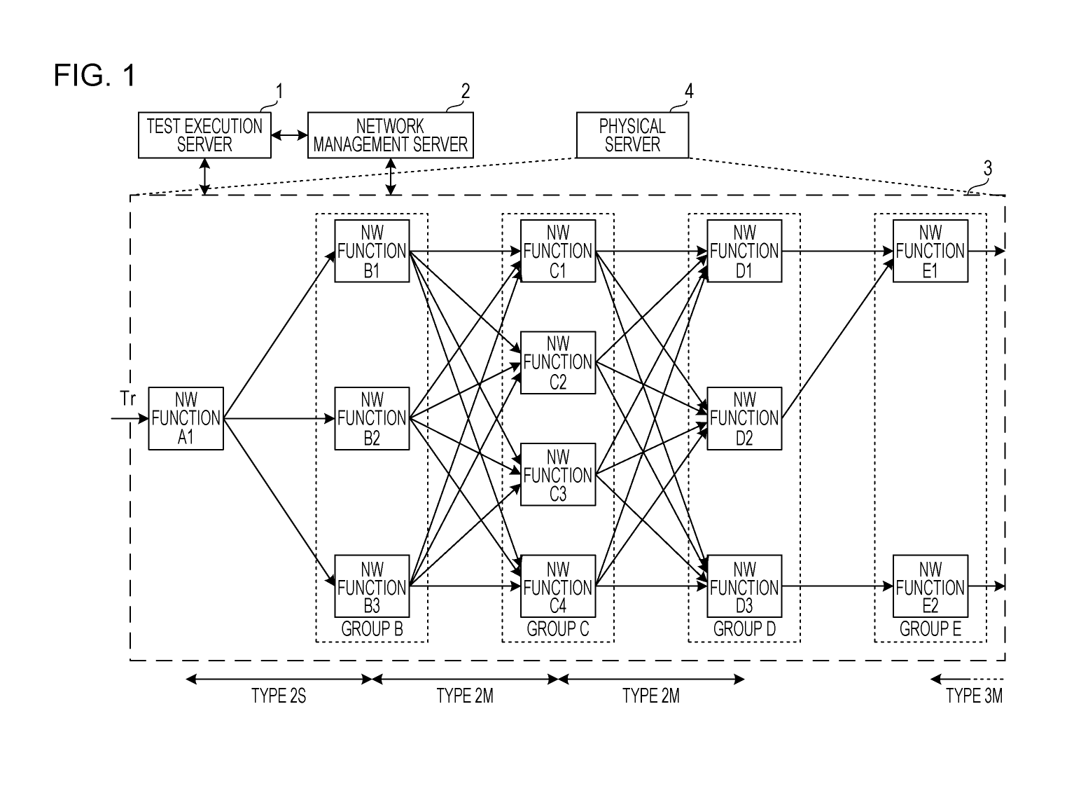

FIG. 1 is a diagram illustrating an exemplary configuration of a network system. The network system includes a test execution server 1, which is an example of a test device, a network management server 2, and a physical server 4 in which a network 3 is virtually formed. The network 3 includes various network function sections (NW functions) A1, B1 to B3, C1 to C4, D1 to D3, E1, and E2 that are coupled to each other. The network 3 may be formed not in a single physical server 4 but in a plurality of physical servers 4 separately.

The physical server 4 executes a predetermined application and thereby forms, for example, as virtual machines, the NW function sections A1, B1 to B3, C1 to C4, D1 to D3, E1, and E2. That is, the NW function sections A1, B1 to B3, C1 to C4, D1 to D3, E1, and E2 are examples of a virtual communication device. The NW function sections A1, B1 to B3, C1 to C4, D1 to D3, E1, and E2 may be physical communication devices.

The NW function sections B1 to B3, C1 to C4, D1 to D3, E1, and E2 are divided into groups B to E. The NW function sections B1 to B3 belong to the group B, the NW function sections C1 to C4 belong to the group C, the NW function sections D1 to D3 belong to the group D, and the NW function sections E1 and E2 belong to the group E.

Traffic Tr for a communication is transferred via the NW function section A1, the group B, the group C, the group D, and the group E in this order (see arrows in the network 3). The NW function sections B1 to B3, C1 to C4, D1 to D3, E1, and E2 execute functions of, for example, a firewall, a proxy server, a load balancer, or the like, on the input traffic Tr, for each of the groups B to E. Similarly, the NW function section A1 also executes a predetermined function.

In between the groups B to E, the NW function sections B1 to B3, C1 to C4, D1 to D3, E1, and E2 operate in individual redundant configuration forms (types). The redundant configuration types will be described later.

The network management server 2 manages the network 3. The network management server 2 performs management of connection configurations and redundant configurations of the NW function sections A1, B1 to B3, C1 to C4, D1 to D3, E1, and E2, paths of the traffic Tr, processing performance of the traffic Tr, resources, and the like.

The test execution server 1 executes a predetermined test on the network 3 that is in operation. Thus, a potential problem that exists in the network 3 is detected and solved. However, when a test is executed on the network 3 that is in operation, an influence on the quality (hereinafter, referred to as “service quality”) of a communication service that is being provided on the network 3 is a concern.

Thus, the test execution server 1 predicts the quality of a communication service during a test on the network 3 that is in operation and determines, based on the predicted quality, whether or not the test is to be actually executed, thereby reducing the influence of the test of the network 3 on the quality of the communication service. That is, in advance of the actual execution of a test, the test execution server 1 performs a simplified simulation of the test to predict the influence of the execution of the test on the network 3 and actually executes the test when it is determined that the influence is within an allowable range. Therefore, the test may be executed only when the network 3 has enough processing performance for the traffic Tr.

Examples of a test that is to be executed on the network 3 include, for example, a test in which a pseudo failure is caused to occur in the NW function sections A1, B1 to B3, C1 to C4, D1 to D3, E1, and E2 and a test in which test traffic is input. The test execution server 1 measures, before the execution of the test, the processing amounts of the traffic Tr in the NW function sections A1, B1 to B3, C1 to C4, D1 to D3, E1, and E2 and the load (CPU usage rate or the like) on the NW function sections A1, B1 to B3, C1 to C4, D1 to D3, E1, and E2, and checks whether or not a preliminary resource is available.

Then, assuming the operation of the network 3 during a test, the test execution server 1 predicts the service quality at the time of the execution of the test in a state checked beforehand. The test execution server 1 acquires, for the prediction, information related to the configuration and performance of the network 3 from the network management server 2.

When a difference between the predicted service quality and the service quality before the execution of the test is within an allowable range or when the predicted service quality satisfies the desired service quality (SLA: service level agreement), the test execution server 1 executes the test. The operation of the test execution server 1 will be described below using an example in which the SLA is used.

In the following example, it is assumed that the NW function section A1 is a virtual load balancer that performs load distribution processing of the traffic Tr on the NW function sections B1 to B3 and the NW function sections B1 to B3 are virtual firewalls that make a defense against a network attack.

First, an example of a test in which a failure is artificially caused to occur in the NW function sections B1 to B3 will be described. It is assumed that, before the execution of a test, the test execution server 1 learns that the current load of traffic processing on the NW function sections B1 to B3 is 66% of a maximum value. It is also assumed that the respective traffic processing performances of the NW function sections B1 to B3 are equal to each other.

The test execution server 1 predicts that, if a failure is artificially caused to occur in one of the NW function sections B1 to B3, the load of traffic processing on the other two of the NW function sections B1 to B3 may be 99% (=66+66/2) by the load distribution processing performed by the NW function section A1. Thus, the load of processing on the NW function sections B1 to B3 is 100% or less, and therefore, the test execution server 1 determines that the service quality during the test satisfies predetermined SLA and the test is to be actually executed. As a result of the determination, the test execution server 1 may artificially cause a failure to occur in one of the NW function sections B1 to B3 without reducing the service quality.

Next, a first example of a test in which test traffic is input will be described. Before the execution of the test, the test execution server 1 learns from the network management server 2 that the transfer performance of each of the NW function sections B1 to B3 for transferring the traffic Tr is 100 Mbps and that the current load of traffic processing on the NW function sections B1 to B3 is 50% of the maximum value (that is, a load of 50 Mbps).

The test execution server 1 predicts that, if test traffic of 150 Mbps is input to the NW function section A1, the load of traffic processing of each of the NW function sections B1 to B3 may be 100% or less because the NW function section A1 equally distributes the test traffic of 150 Mbps to the NW function sections B1 to B3, that is, 50 Mbps to each of the NW function sections B1 to B3.

Thus, the test execution server 1 determines that the service quality during the test satisfies predetermined SLA and the test is to be actually executed. As a result of the determination, the test execution server 1 may input test traffic of 150 Mbps or less to the NW function section A1 without reducing the service quality.

Next, a second example of a test in which test traffic is input will be described. Before the execution of the test, the test execution server 1 learns from the network management server 2 that the transfer performance of each of the NW function sections B1 to B3 for transferring the traffic Tr is 100 Mbps and that the current load of traffic processing on the NW function sections B1 to B3 is 70% of the maximum value (that is, a load of 70 Mbps). Furthermore, the test execution server 1 learns from the network management server 2 that a threshold for determination of a scale-out (resource addition) of the NW function sections B1 to B3 is 80% of the maximum value of the load of traffic processing and that a preliminary resource is available. The resource is, for example, an allocation of a CPU usage rate or a memory usage rate of the physical server 4.

The test execution server 1 predicts that, if test traffic of 60 Mbps is input to the NW function section A1, the load of traffic processing on each of the NW function sections B1 to B3 may be 90% because the NW function section A1 equally distributes the test traffic of 60 Mbps to the NW function sections B1 to B3, that is, 20 Mbps to each of the NW function sections B1 to B3. Thus, the load exceeds the above-described threshold and scale-out of the NW function sections B1 to B3 is performed, and therefore, the test execution server 1 determines that the test may be executed without reducing the service quality. As a result of the determination, the test execution server 1 inputs test traffic of 60 Mbps or less to the NW function section A1 without reducing the service quality.

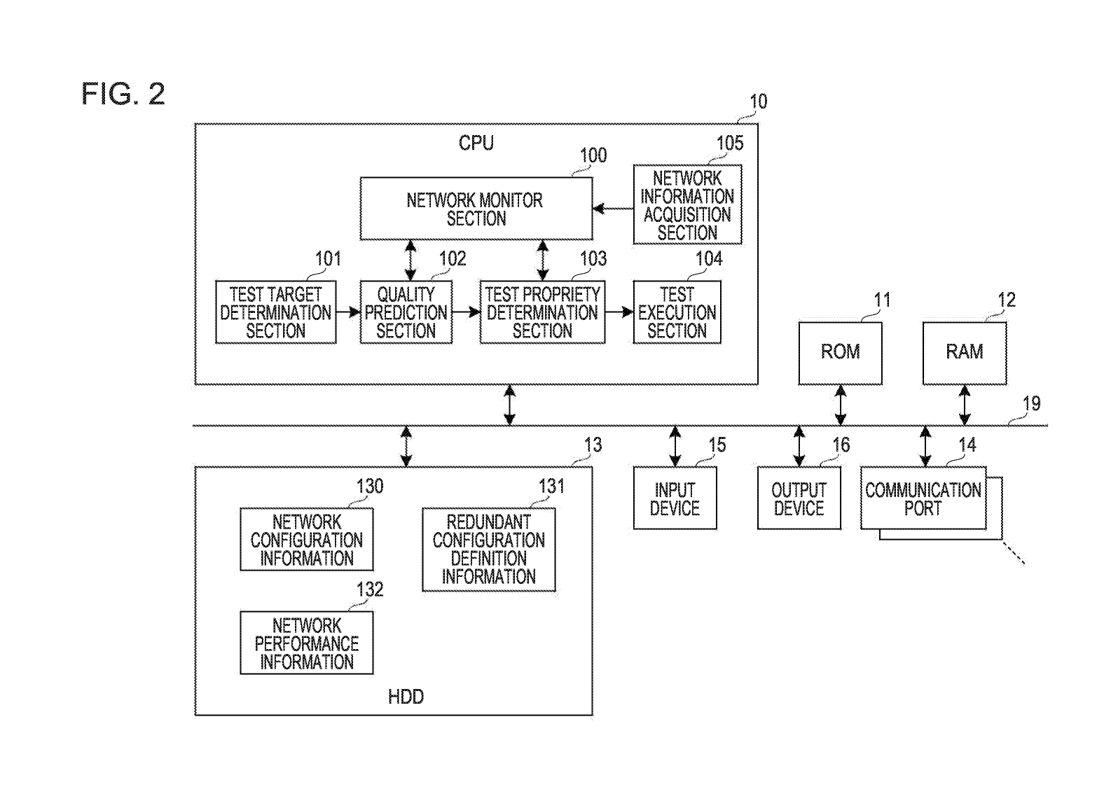

FIG. 2 is a diagram illustrating an exemplary configuration of the test execution server 1. Note that, the physical server 4 also has a similar configuration to that illustrated in FIG. 2. The test execution server 1 includes a CPU 10, read-only memory (ROM) 11, random access memory (RAM) 12, a hard disk drive (HDD) 13, a plurality of communication ports 14, an input device 15, and an output device 16. The CPU 10 is coupled to the ROM 11, the RAM 12, the HDD 13, the plurality of communication ports 14, the input device 15, and the output device 16 via a bus 19 so as to input and output signals from and to each other.

A program to be executed by the CPU 10 is stored in the ROM 11. The RAM 12 functions as a working memory of the CPU 10. The communication ports 14 is, for example, a wireless local area network (LAN) card or a network interface card (NIC) and transmits and receives a packet to and from the network management server 2 and the network 3. An Internet protocol (IP) packet may be employed as the packet, but the packet is not limited thereto.

The input device 15 is a device that inputs information to the test execution server 1. As the input device 15, for example, a keyboard, a mouse, a touch panel, or the like may be employed. The input device 15 outputs the input information to the CPU 10 via the bus 19.

The output device 16 is a device that outputs information of the test execution server 1. As the output device 16, for example, a display, a touch panel, a printer, or the like is employed. The output device 16 acquires information from the CPU 10 via the bus 19 and outputs the information.

The CPU 10 reads the program from the ROM 11 and executes the program to function as a network monitor section 100, a test target determination section 101, a quality prediction section 102, a test propriety determination section 103, a test execution section 104, and a network information acquisition section 105. Network configuration information 130, redundant configuration definition information 131, and network performance information 132 are stored in the HDD 13. As a storage device of each of the network configuration information 130, the redundant configuration definition information 131, and the network performance information 132, a non-volatile memory, such as an erasable programmable ROM (EPROM) or the like may be used instead of the HDD 13.

For example, the network information acquisition section 105 acquires the network configuration information 130, the redundant configuration definition information 131, and the network performance information 132 from the network management server 2 via the communication ports 14. The network configuration information 130 is information related to a configuration of the NW function sections A1, B1 to B3, C1 to C4, D1 to D3, E1, and E2 in the network 3, and for example, includes information of connection configurations, configurations of the groups B to E, a condition for scale-out, or the like.

The redundant configuration definition information 131 indicates the definitions of redundant configuration types between the NW function sections A1, B1 to B3, C1 to C4, D1 to D3, E1, and E2. More specifically, the redundant configuration definition information 131 indicates redundant configuration types between the groups B to E.

The network performance information 132 indicates the performances of the NW function sections A1, B1 to B3, C1 to C4, D1 to D3, E1, and E2. The network performance information 132 indicates, for example, the performances of the NW function sections A1, B1 to B3, C1 to C4, D1 to D3, E1, and E2 for performing traffic processing, that is, the maximum transfer speed for transferring the traffic Tr. The network configuration information 130, the redundant configuration definition information 131, and the network performance information 132 may be information input from the input device 15.

The network monitor section 100 is an example of a measurement section and measures the service quality when a test is not executed. More specifically, the network monitor section 100 measures actual service quality before the execution of a test. Also, the network monitor section 100 measures the service quality even after the test is terminated.

When the network monitor section 100 is informed of, for example, the completion of acquisition of information from the network information acquisition section 105, the network monitor section 100 starts monitoring of the NW function sections A1, B1 to B3, C1 to C4, D1 to D3, E1, and E2 on the basis of the network configuration information 130. The network monitor section 100 monitors, for example, the number of packets transmitted and received by the NW function sections A1, B1 to B3, C1 to C4, D1 to D3, E1, and E2, the load of traffic processing (a CPU usage rate or the like), and whether or not there is a preliminary resource.

The test target determination section 101 determines a test target NW function section from among the NW function sections A1, B1 to B3, C1 to C4, D1 to D3, E1, and E2. The test target NW function section may be determined at random or in accordance with a predetermined rule. The test target determination section 101 informs the quality prediction section 102 of the test target NW function section.

The quality prediction section 102 is an example of a prediction section and predicts the service quality under a test on the network 3 that is in operation. The quality prediction section 102 acquires, for prediction of the service quality, a result of monitoring the network monitor section 100, the network configuration information 130, the redundant configuration definition information 131, and the network performance information 132. The quality prediction section 102 recognizes, on the basis of the network configuration information 130, for example, the configuration of the NW function sections A1, B1 to B3, C1 to C4, D1 to D3, E1, and E2 illustrated in FIG. 1.

The quality prediction section 102 identifies redundant configuration types between the NW function sections A1, B1 to B3, C1 to C4, D1 to D3, E1, and E2 and predicts the service quality in accordance with the identified redundant configuration types. The quality prediction section 102 associates the redundant configuration types with the NW function section A1 and the groups B to E, based on the redundant configuration definition information 131. Association of the redundant configuration types may be performed, for example, in accordance with an input made from the input device 15 or in accordance with predetermined attribute information of the respective NW function sections A1, B1 to B3, C1 to C4, D1 to D3, E1, and E2.

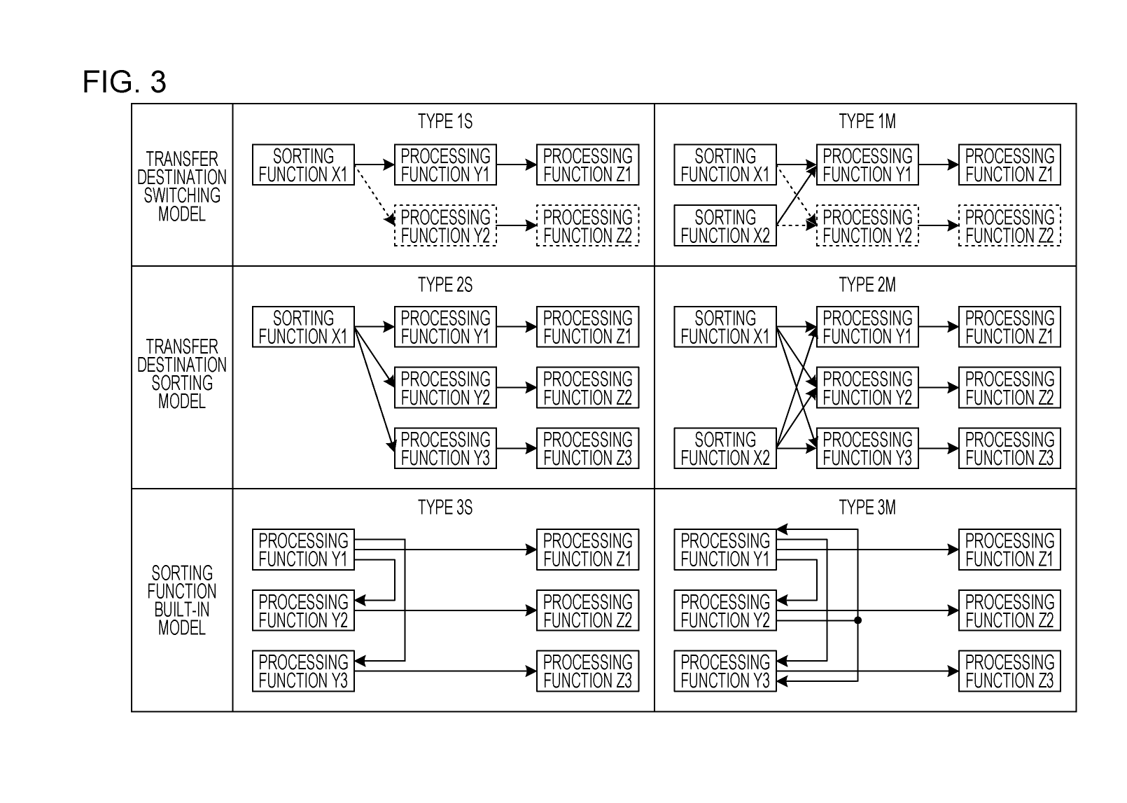

In FIG. 3, an example of the redundant configuration definition information 131 is illustrated. The redundant configuration definition information 131 defines redundant configurations on the basis of a relationship between sorting function sections X1 and X2 (sorting functions) and processing function sections Y1 to Y3 and Z1 to Z3 (processing functions), for example, in six types 1S to 3S and 1M to 3M. There may be a case where the number of the processing function sections Y1 to Y3 and the number of the processing function sections Z1 to Z3 are not identical to each other, and also, there may be a case where the processing function sections Y1 to Y3 and the processing function sections Z1 to Z3 are not fixedly coupled. A coupling relationship between the processing function sections Y1 to Y3 and the processing function sections Z1 to Z3 is dynamically changed, for example, in accordance with the type of the traffic Tr or by a network control device.

The sorting function sections X1 and X2 sort the traffic Tr that is a processing target to the processing function sections Y1 to Y3 and Z1 to X3 and the processing function sections Y1 to Y3 and Z1 to Z3 process the sorted traffic Tr. The traffic Tr is transferred, as indicated by arrows in FIG. 3, from the sorting function sections X1 and X2 to the group of the processing function sections Y1 to Y3 and further to the group of the processing function sections Z1 to Z3 in this order. Each of types 1S to 3S and 1M to 3M will be described below.

The types 1S and 1M are classified as a transfer destination switching model. In the transfer destination switching model, the traffic Tr is transferred to only the processing function sections Y1 to Y3 and Z1 to Z3 selected by the sorting function sections X1 and X2. In the type 1S, the sorting function section X1 sorts the processing of the traffic Tr to only the selected processing function sections Y1 and Z1. In the type 1M, the plurality of sorting function sections X1 and X2 sort the processing of the traffic Tr to only the selected processing function sections Y1 and Z1. The selection of the processing function sections Y1 to Y3 and Z1 to Z3 is switched in accordance with network control.

The types 2S and 2M are classified as a transfer destination sorting model. In the transfer destination sorting model, the traffic Tr is sorted to the plurality of processing function sections Y1 to Y3 and Z1 to Z3. In the type 2S, the sorting function section X1 sorts the processing of the traffic Tr to each of the processing function sections Y1 to Y3 and Z1 to Z3 in accordance with predetermined control. In the type 2M, a plurality of sorting function sections X1 and X2 sort the processing of the traffic Tr to each of the processing function sections Y1 to Y3 and Z1 to Z3 in accordance with predetermined control.

The types 3S and 3M are classified as a sorting function built-in model. In the sorting function built-in model, the processing function sections Y1 to Y3 and Z1 to Z3 themselves are capable of sorting the processing of the traffic Tr, and therefore, the sorting function sections X1 and X2 are not used. In the type 3S, the processing function section Y1 sorts the processing to the other processing function sections Y2 and Y3 within the group and the processing function sections Z1 to Z3. In the type 3M, each of the plurality of processing function sections Y1 and Y2 sorts the processing to the other ones of the processing function sections Y1 to Y3 within the group and the processing function sections Z1 to Z3.

With reference to FIG. 2 again, the quality prediction section 102 identifies the redundant configuration types between the NW function sections A1, B1 to B3, C1 to C4, D1 to D3, E1, and E2 illustrated in FIG. 1, based on the redundant configuration definition information 131. For example, a redundant configuration between the NW function section A1 and the NW function sections B1 to B3 of the group B is identified as a redundant configuration of the type 2S and a redundant configuration between the NW function sections B1 to B3 of the group B and the NW function sections C1 to C4 of the group C is identified as a redundant configuration of the type 2M. Also, a redundant configuration between the NW function sections C1 to C4 of the group C and the NW function sections D1 to D3 of the group D is identified as a redundant configuration of the type 2M.

A redundant configuration is not formed between the NW function sections D1 to D3 of the group D and the NW function sections E1 and E2 of the group E, and therefore, type identification is not performed. A redundant configuration between the NW function sections E1 and E2 of the group E and a NW function section outside the network 3 is identified as a redundant configuration of the type 3M.

The quality prediction section 102 predicts the service quality in accordance with the identified redundant configuration types, and thus, performs highly accurate prediction while considering path switching and load distribution when a failure occurs. When there is no redundant configuration, as between the NW function sections D1 to D3 of the group D and the NW function sections E1 and E2 of the group E, the quality prediction section 102 predicts the service quality, based on the fixed path and load acquired from the network configuration information 130 and the network performance information 132. The quality prediction section 102 informs the test propriety determination section 103 of the predicted service quality.

The test propriety determination section 103 is an example of a determination section and determines, based on the service quality predicted by the quality prediction section 102, whether or not the test is to be executed. More specifically, when a difference between the predicted service quality and the service quality before the execution of the test is within an allowable range or when the predicted service quality satisfies a desired service quality, the test propriety determination section 103 determines that the test is to be executed. In the following description, an example will be described in which it is determined that the test is to be executed when a difference between the predicted service quality and the service quality before the execution of the test is within an allowable range.

The test propriety determination section 103 acquires the actual service quality before the execution of the test from a monitoring result of the network monitor section 100 and compares the actual service quality to the service quality predicted by the quality prediction section 102. For example, it is assumed that, when a throughput (a processing rate) of the traffic Tr is used as the service quality, a predicted throughput is 90 Mbps and a throughput before the execution of the test is 100 Mbps.

When the allowable range of the difference in service quality is set to 20 Mbps, the difference between the predicted throughput and the throughput before the execution of the test is 10 Mbps (=100−90) and is within the allowable range, and thus the test propriety determination section 103 determines that the test is to be executed. When the allowable range of the difference in service quality is set to 0 Mbps, the calculated difference is out of the allowable range, and the test propriety determination section 103 determines that the test is not to be executed. The difference used in this example is a value obtained by deducting the predicted throughput from the throughput before the execution of the test.

Thus, the test propriety determination section 103 compares the service quality measured by the network monitor section 100 and the service quality predicted by the quality prediction section 102 to each other and determines, based on a result of the comparison, the execution of the test. Thus, using the service quality before the execution of the test as a reference, reduction in service quality due to the execution of the test is avoided.

The test propriety determination section 103 informs the test execution section 104 of a result of the determination on whether or not the test is to be executed. The test execution section 104 is an example of an execution section and executes a test on the network 3 in accordance with the result of the determination. More specifically, when the test propriety determination section 103 determines that the test is to be executed, the test execution section 104 executes the test and, when the test propriety determination section 103 determines that the test is not to be executed, the test execution section 104 does not execute the test.

Thus, the test execution section 104 may execute a test or cancel the test beforehand in accordance with the influence of the test on a communication service that is being provided on the network 3. Therefore, the influence of the test of the network 3 that is in operation on the service quality is reduced.

As a test, as described above, a test (hereinafter, referred to as a “failure test”) in which a failure is artificially caused to occur in a test target NW function section out of the NW function sections A1, B1 to B3, C1 to C4, D1 to D3, E1, and E2 or a test (hereinafter, referred to as a “load test”) in which test traffic is input as a load to the network 3 may be employed.

In the failure test, the quality prediction section 102 predicts the service quality when it is assumed that a failure occurs in the test target NW function section out of the NW function sections A1, B1 to B3, C1 to C4, D1 to D3, E1, and E2 in the network 3. The test propriety determination section 103 determines, based on the service quality predicted by the quality prediction section 102, whether or not the failure test is to be executed. Thus, the influence of the failure test on the service quality is reduced.

In the load test, the quality prediction section 102 predicts the service quality when it is assumed that test traffic is input to the test target NW function section out of the NW function sections A1, B1 to B3, C1 to C4, D1 to D3, E1, and E2 in the network 3. The test propriety determination section 103 determines, based on the service quality predicted by the quality prediction section 102, whether or not the load test is to be executed. Thus, the influence of the load test on the service quality is reduced. Next, processing performed by the test execution server 1 will be described.

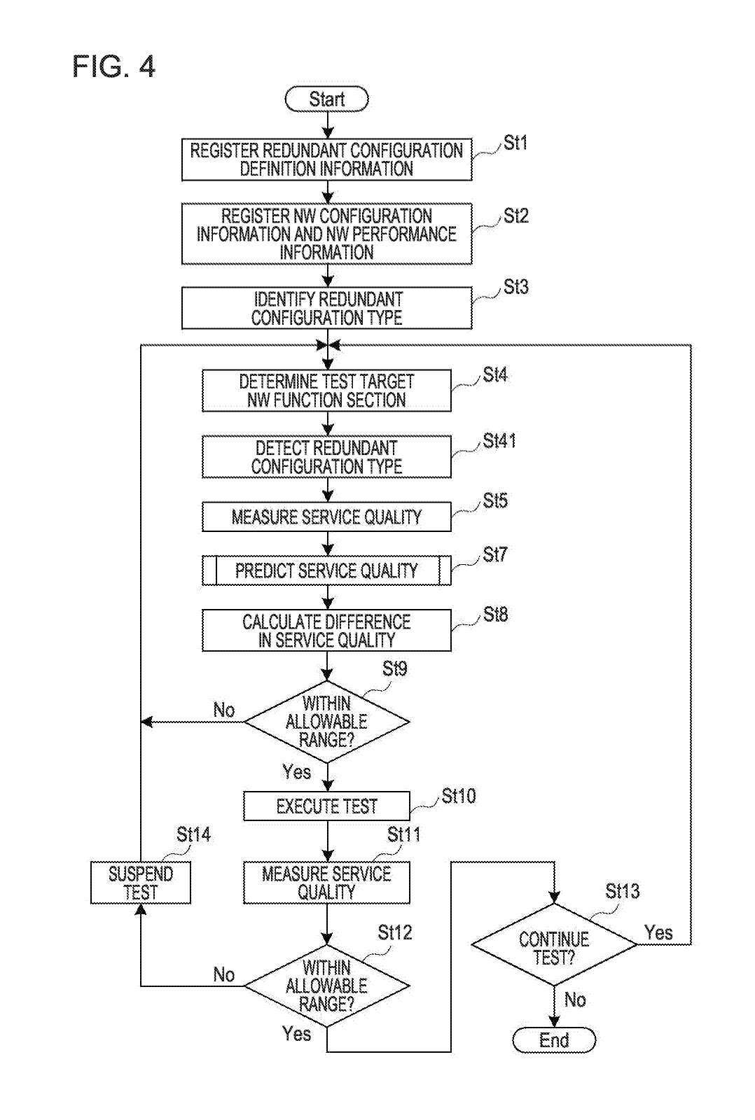

FIG. 4 is a flowchart illustrating a first example of processing performed by the test execution server 1. The network information acquisition section 105 acquires and registers the redundant configuration definition information 131 (SU). The redundant configuration definition information 131 may be acquired via the input device 15, or may be acquired from the network management server 2. The acquired redundant configuration definition information 131 is held in the HDD 13.

Next, the network information acquisition section 105 acquires and registers the network configuration information 130 and the network performance information 132 (St2). The network configuration information 130 and the network performance information 132 may be acquired via the input device 15, or may be acquired from the network management server 2. The acquired network configuration information 130 and the acquired network performance information 132 are held in the HDD 13. As the network configuration information 130, for example, “Network Descriptor” defined by ETSI NFV ISG or “Heat Template” used in Open Stack software may be employed. ETSI NFV ISG is an abbreviation of European Telecommunication Standards Institute Network Function Virtualization Industry Specification Group.

Next, the quality prediction section 102 refers to the network configuration information 130 and the redundant configuration definition information 131 to identify the redundant configuration types 1S to 3S and 1M to 3M between the NW function sections A1, B1 to B3, C1 to C4, D1 to D3, E1, and E2 (St3). At this time, as described above, the quality prediction section 102 associates one of the redundant configuration types 1S to 3S and 1M to 3M with respective connections between the NW function section A1 and the groups B to E. The association is performed in accordance with input from the input device 15 made by an operator of the test execution server 1 or in accordance with attribute information of the NW function sections A1, B1 to B3, C1 to C4, D1 to D3, E1, and E2. This processing is not performed for NW functions with no redundant configuration.

Next, the test target determination section 101 determines, based on the network configuration information 130, a test target NW function section out of the NW function sections A1, B1 to B3, C1 to C4, D1 to D3, E1, and E2 at random or in accordance with a predetermined rule (St4). For example, in a failure test, one of the NW function sections A1, B1 to B3, C1 to C4, D1 to D3, E1, and E2 in which a pseudo failure occurs is determined, and in a load test, one of the NW function sections A1, B1 to B3, C1 to C4, D1 to D3, E1, and E2 to which test traffic is input as a load is determined.

Next, the quality prediction section 102 detects one of the redundant configuration types 1S to 3S and 1M to 3M, which include the determined test target NW function section (St41). For example, when the NW function section C1 is determined as the test target, the quality prediction section 102 detects each of the redundant configuration type 2M between the group C of the NW function section C1 and the group B in the previous stage thereof and the redundant configuration type 2M between the group C of the NW function section C1 and the group D in the subsequent stage thereof.

Next, the network monitor section 100 measures actual service quality in the current network 3 (St5). At this time, the network monitor section 100 measures the total of traffic amounts transmitted by the NW function sections which correspond to the sorting function sections X1 and X2, among the NW function sections A1, B1 to B3, C1 to C4, D1 to D3, E1, and E2, in the redundant configuration types 1S to 3S and 1M to 3M which are detected by the quality prediction section 102. The network monitor section 100 also measures the total of traffic amounts received by the NW function sections which correspond to the processing function sections Y1 to Y3 and Z1 to Z3, among the NW function sections A1, B1 to B3, C1 to C4, D1 to D3, E1, and E2, in the last stage of the redundant configuration types 1S to 3S and 1M to 3M which are detected by the quality prediction section 102.

In the above-described example, the network monitor section 100 measures traffic amounts received by the NW function sections C1 to C4 for the redundant configuration between the groups B and C, and measures traffic amounts received by the NW function sections D1 to D3 for the redundant configuration between the groups C and D. Thus, the network monitor section 100 measures actual service quality in the current network 3.

Next, the quality prediction section 102 predicts service quality during a test on the network 3 that is in operation (St7). In the above-described example, when a failure test is performed, for example, the quality prediction section 102 removes the NW function section C1, in which a failure is caused to occur, from the network 3, and thereby, generates a topology between the other NW function sections C2 to C4 in the group C and the group B in the previous stage thereof and between the other NW function sections C2 to C4 in the group C and the group D in the subsequent stage thereof. Then, the quality prediction section 102 calculates, as service quality, the total of maximum throughputs of the traffic Tr through the shortest paths between the start point (the group B) and the end point (the group D) in the topology. This processing will be described later using another example.

Next, the test propriety determination section 103 compares the service quality measured by the network monitor section 100 and the service quality predicted by the quality prediction section 102 (St8). At this time, as described above, the test propriety determination section 103 calculates a difference between the measured service quality and the predicted service quality. In the above-described example, the throughput of the traffic Tr is used as service quality, and therefore, the difference between the measured service quality and the predicted service quality is calculated. Thus, the test propriety determination section 103 may detect the influence of the test on service quality, based on the difference in throughput.

The test propriety determination section 103 determines whether or not the difference in service quality is within an allowable range (St9). In the above-described example, the test propriety determination section 103 determines whether or not the difference in throughput is larger than a predetermined value set as the allowable range. When the difference in service quality is not within the allowable range (NO in St9), St4 described above is executed again.

When the difference in service quality is within the allowable range (YES in St9), the test execution section 104 executes the test on the network 3 (St10). Thus, the test execution section 104 executes the test in accordance with a result of the determination of the test propriety determination section 103, and therefore, when the influence of the test on the service quality is large, the test may be cancelled before the test is started.

In a failure test, for example, the test execution section 104 instructs the test target NW function section out of the NW function sections A1, B1 to B3, C1 to C4, D1 to D3, E1, and E2 to shut down, and thereby, causes the test target NW function section to stop its operation. In a load test, the test execution section 104 inputs test traffic Tr to the test target NW function section out of the NW function sections A1, B1 to B3, C1 to C4, D1 to D3, E1, and E2.

Next, the network monitor section 100 measures actual service quality after the execution of the test (St11). The measurement is performed in a similar manner to that in St5. Next, the test execution section 104 determines whether or not the difference between the service quality measured in St5 and the service quality measured in St11 is within the allowable range (St12).

Thus, the test propriety determination section 103 compares the service quality before and after the execution of the test to each other. In the above-described example, the test propriety determination section 103 calculates the difference between throughputs before and after the execution of the test and determines whether or not the difference is larger than the predetermined value set as the allowable range.

When the difference in service quality is out of the allowable range (NO in St12), the test execution section 104 suspends the test that is being executed (St14). Thus, the influence of the test on the service quality is not increased. After the suspension of the test, St4 described above is executed again.

When the difference in service quality is within the allowable range (YES in St12), the test execution section 104 determines, for example, based on input from the input device 15, whether or not the test is to be continued (St13). At this time, in order to inform the test result to the operator of the test execution server 1, the output device 16 may output the contents of the test result.

When the test is to be continued (YES in St13), the test execution server 1 executes St4 described above again and, when the test is not to be continued (NO in St13), the processing is terminated. The test execution server 1 executes the processing as described above.

Next, St7 described above will be described using an example.

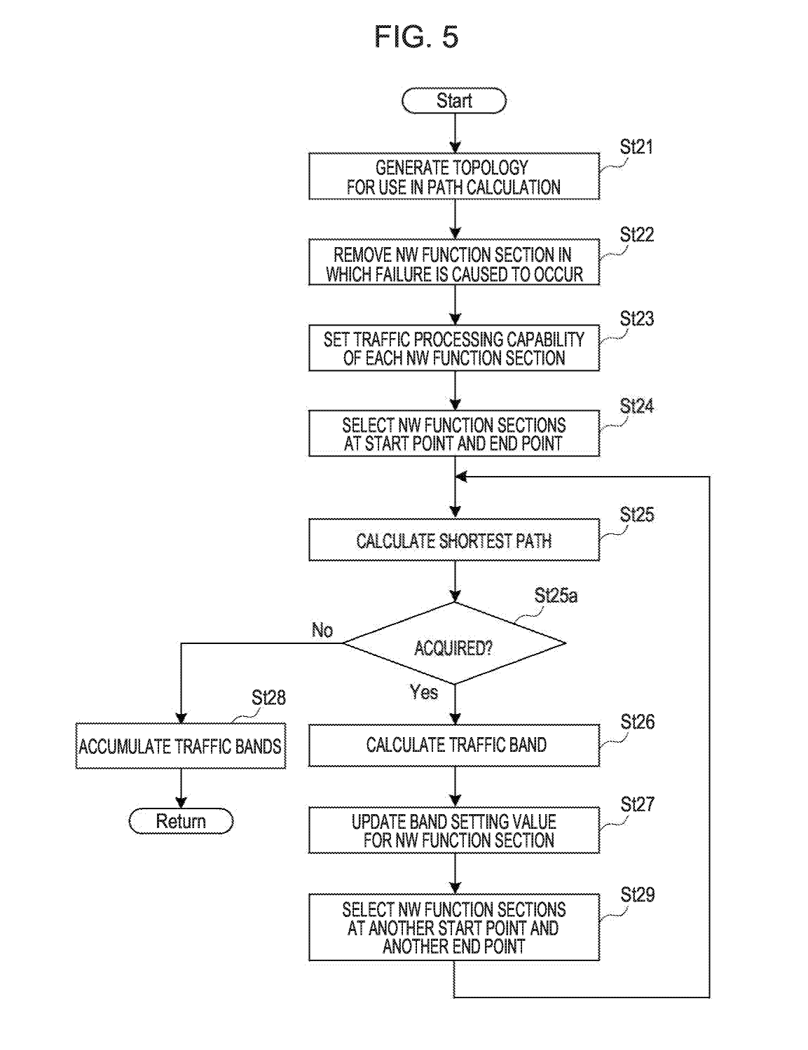

FIG. 5 is a flowchart illustrating a first example of service quality prediction processing. This processing is executed in St7 of FIG. 4. This processing is executed in a failure test.

The quality prediction section 102 generates, based on the configuration of the network 3 acquired from the network configuration information 130, a topology for use in path calculation (St21). In this example, a different configuration from that of the example of FIG. 1 will be described.

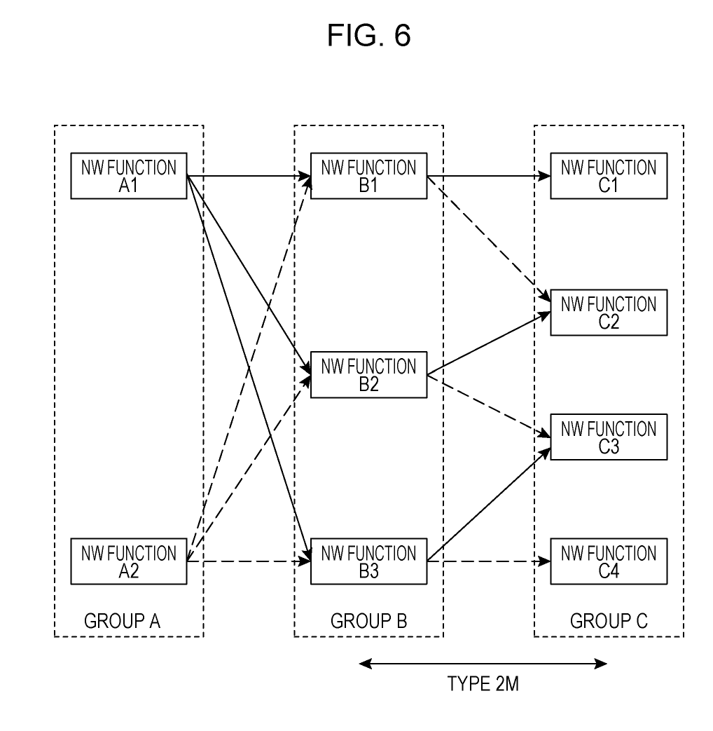

In FIG. 6, an exemplary configuration of the NW function sections is illustrated. The configuration of the NW function sections in this example corresponds to a configuration obtained by adding a NW function section A2 to the configuration of the NW function sections of FIG. 1. The NW function sections A1 and A2 belong to a group A.

In the example, it is assumed that a redundant configuration type between the groups A and B is the type 2M. Therefore, the NW function sections B1 to B3 of the group B transfer the traffic Tr input from the group A in the previous stage to the group C in the subsequent stage in accordance with predetermined control. More specifically, the NW function section B1 transfers the traffic Tr input from the NW function section A1 to the NW function section C1 (see arrows of solid lines) and the traffic Tr input from the NW function section A2 to the NW function section C2 (see arrows of broken lines).

The NW function section B2 transfers the traffic Tr input from the NW function section A1 to the NW function section C2 (see arrows of solid lines) and transfers the traffic Tr input from the NW function section A2 to the NW function section C3 (see arrows of broken lines). The NW function section B3 transfers the traffic Tr input from the NW function section A1 to the NW function section C3 (see arrows of solid lines), and transfers the traffic Tr input from the NW function section A2 to the NW function section C4 (see arrows of broken lines).

The quality prediction section 102 simplifies a redundant configuration control logic and, assuming that the groups A to C are coupled to each other in a full mesh form, generates a topology of the NW function sections A1, A2, B1 to B3, and C1 to C4 for use in path calculation.

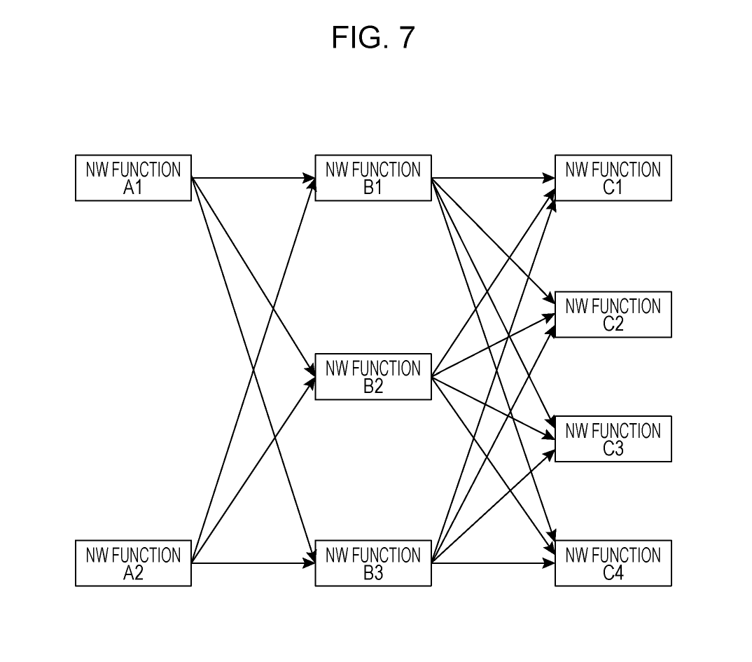

In FIG. 7, an example of the topology of the NW function sections A1, A2, B1 to B3, and C1 to C4 for use in path calculation is illustrated. The NW function sections A1, A2, B1 to B3, and C1 to C4 are coupled to each other in a full mesh form, as indicated by arrows.

With reference to FIG. 5 again, the quality prediction section 102 removes a NW function section out of the NW function sections A1, A2, B1 to B3, and C1 to C4, in which a failure is caused to occur, that is, a NW function section of the NW function sections A1, A2, B1 to B3, and C1 to C4, which is determined by the test target determination section 101, from the topology (St22).

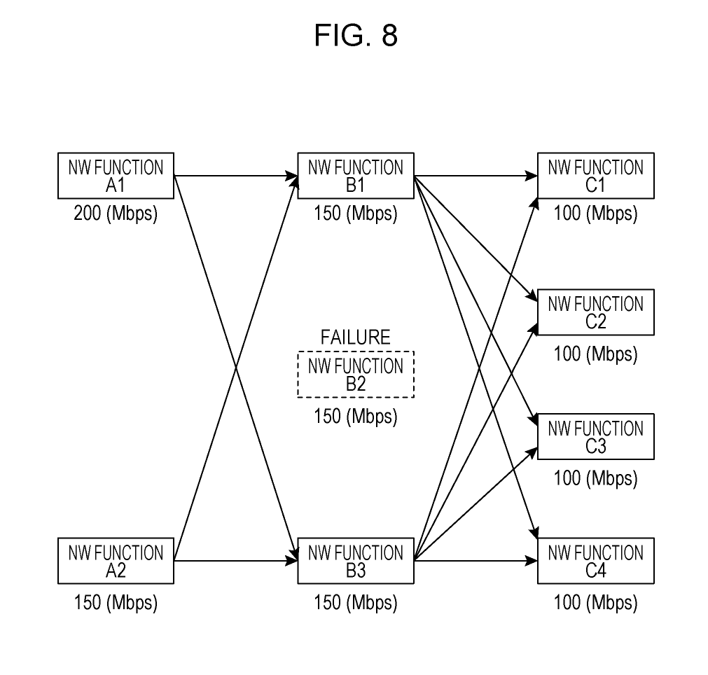

In FIG. 8, an example of a topology when the NW function section B2 with a failure is removed is illustrated. When the NW function section B2 is a test target, the quality prediction section 102 removes the NW function section B2 with a failure from the topology of FIG. 7 (the broken line in FIG. 8 indicates that the NW function section B2 is removed).

With reference to FIG. 5 again, the quality prediction section 102 sets, based on the network performance information 132, the traffic processing capability of each of the NW function sections B1 to B3 and C1 to C4 (St23). More specifically, the quality prediction section 102 sets the maximum transferable traffic band (hereinafter, referred to as a “band setting value”) for transferring the traffic Tr for the respective NW function sections B1 to B3 and C1 to C4. An example of the maximum transferable traffic band for the respective NW function sections B1 to B3 and C1 to C4 is illustrated in FIG. 8. The traffic bands of the traffic Tr transmitted by the NW function sections A1 and A2 are measured to be 200 Mbps and 150 Mbps, respectively, by the network monitor section 100.

Next, the quality prediction section 102 selects a start point and an end point of a path of the traffic Tr from the NW function sections A1, A2, and C1 to C4 (St24). Next, the quality prediction section 102 calculates the shortest path coupling together the selected start point and the selected end point (St25). As a method for calculating the shortest path, for example, Dijkstra's algorithm may be used.

As a result of the calculation, when the shortest path is acquired (YES in St25a), the quality prediction section 102 calculates, based on the band setting value set in St23, the transferable traffic band of the calculated shortest path (St26). The quality prediction section 102 holds the calculated transferable traffic band in the HDD 13 or the like. Next, the quality prediction section 102 updates each of the respective band setting values by deducting the calculated transferable traffic band from the corresponding one of the band setting values for the NW function sections A1, A2, and C1 to C4 on the shortest path (St27).

Next, the quality prediction section 102 selects another start point and another end point of a path of the traffic Tr from the NW function sections A1, A2, and C1 to C4 (St29). Thereafter, St25 described above is executed again.

When the shortest path is not acquired (NO in St25a), the quality prediction section 102 accumulates the transferable traffic band s that are calculated and held in St26 (St28). Thus, when a failure is caused to occur in the NW function section B2, the transferable traffic band for transferring the traffic Tr in the redundant configuration including the NW function section B2 is calculated. That is, the service quality when it is assumed that a failure is caused to occur in the NW function section B2 is predicted. Thereafter, St8 of FIG. 4 is executed.

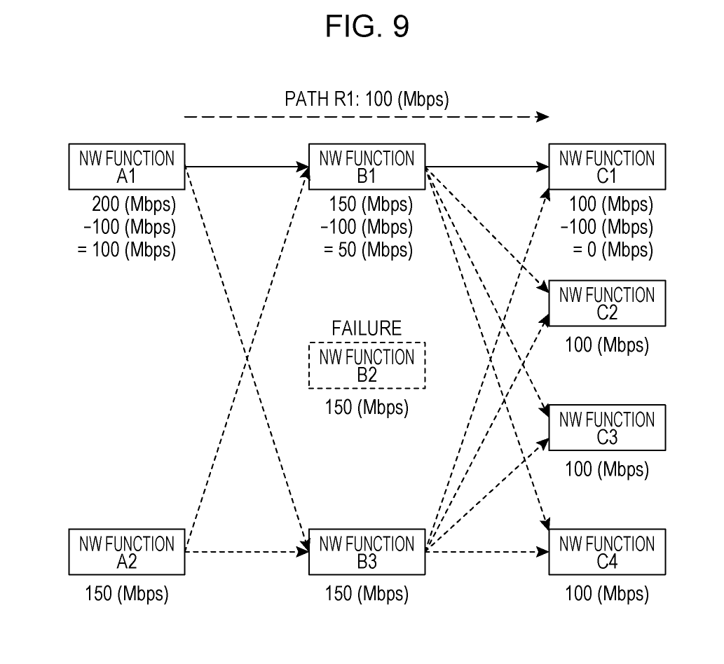

In FIGS. 9 to 12, a method for calculating the transferable traffic band of each path in St25 to St29 described above is illustrated. First, as illustrated in FIG. 9, the quality prediction section 102 selects the NW function section A1 as the start point and the NW function section C1 as the end point, and calculates a shortest path R1 between the start point and the end point. The shortest path R1 passes through the NW function sections A1, B1, and C1 in this order.

Next, the quality prediction section 102 calculates the transferable traffic band of the shortest path R1. The transferable traffic band of the shortest path R1 is calculated to be 100 Mbps, which is the smallest of band setting values of the NW function sections A1, B1, and C1. The quality prediction section 102 holds the transferable traffic band of the shortest path R1 and updates the band setting values of the NW function sections A1, B1, and C1.

More specifically, the quality prediction section 102 deducts the transferable traffic band (100 Mbps) of the shortest path R1 from the band setting values of the NW function sections A1, B1, and C1. For example, for the band setting value of the NW function section A1, 100 Mbps is obtained by deducting 100 Mbps from the initial value 200 Mbps. For the band setting value of the NW function section B1, 50 Mbps is obtained by deducting 100 Mbps from the initial value 150 Mbps. For the band setting value of the NW function section C1, 0 Mbps is obtained by deducting 100 Mbps from the initial value 100 Mbps.

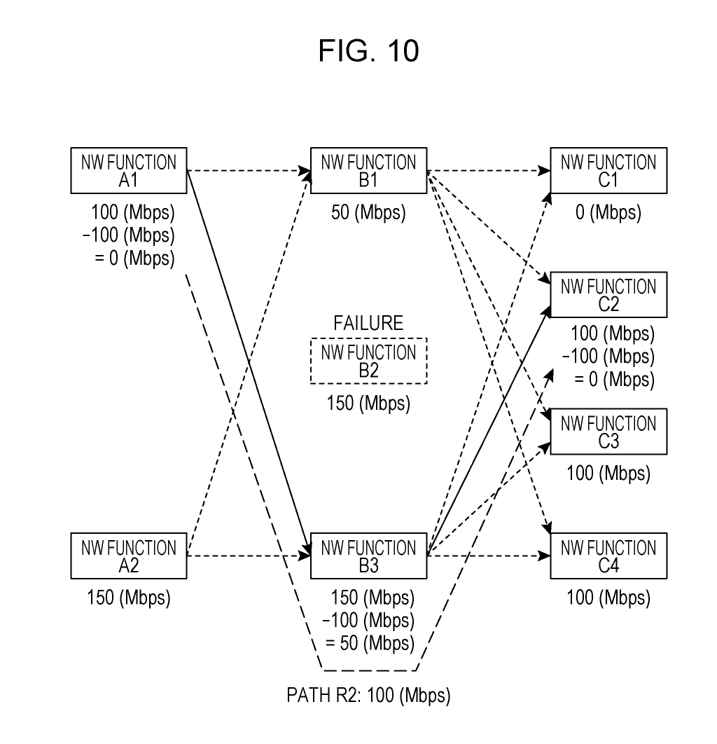

Next, as illustrated in FIG. 10, the quality prediction section 102 selects the NW function section A1 as the start point and the NW function section C2 as the end point, and calculates a shortest path R2 between the start point and the end point. The shortest path R2 passes through the NW function sections A1, B3, and C2 in this order.

Next, the quality prediction section 102 calculates the transferable traffic band of the shortest path R2. The transferable traffic band of the shortest path R2 is calculated to be 100 Mbps, which is the smallest of the band setting values of the NW function sections A1, B3, and C2. The quality prediction section 102 holds the transferable traffic band of the shortest path R2 and updates the band setting values of the NW function sections A1, B3, and C2. The update method is as described above.

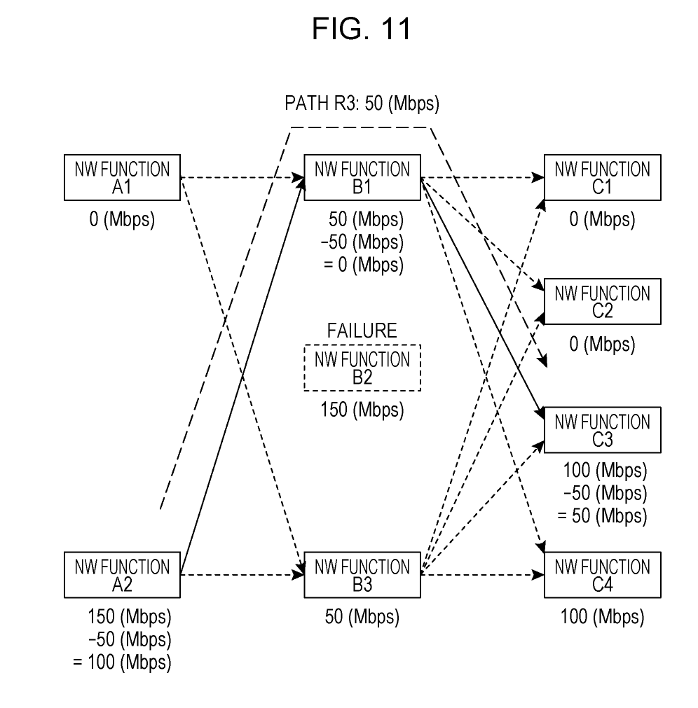

Next, as illustrated in FIG. 11, the quality prediction section 102 selects the NW function section A2 as the start point and the NW function section C3 as the end point, and calculates a shortest path R3 between the start point and the end point. The shortest path R3 passes through the NW function sections A2, B1, and C3 in this order.

Next, the quality prediction section 102 calculates the transferable traffic band of the shortest path R3. The transferable traffic band of the shortest path R3 is calculated to be 50 Mbps, which is the smallest of the band setting values of the NW function sections A2, B1, and C3. The quality prediction section 102 holds the transferable traffic band of the shortest path R3 and updates the band setting values of the NW function sections A2, B1, and C3. The update method is as described above.

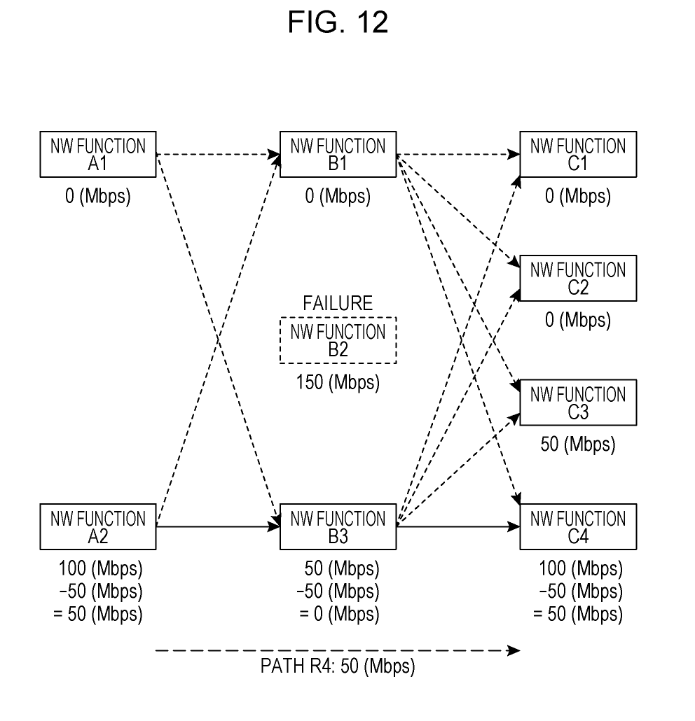

Next, as illustrated in FIG. 12, the quality prediction section 102 selects the NW function section A2 as the start point and the NW function section C4 as the end point, and calculates a shortest path R4 between the start point and the end point. The shortest path R4 passes through the NW function sections A2, B3, and C4 in this order.

Next, the quality prediction section 102 calculates the transferable traffic band of the shortest path R4. The transferable traffic band of the shortest path R4 is calculated to be 50 Mbps, which is the smallest of the band setting values of the NW function sections A2, B3, and C4. The quality prediction section 102 holds the transferable traffic band of the shortest path R4 and updates the band setting values of the NW function sections A2, B3, and C4. The update method is as described above.

Thus, each of the band setting values of the NW function sections B1 and B3 of the group B is 0 Mbps. Therefore, the quality prediction section 102 determines that there is no other path through which the traffic Tr may be transferred and accumulates the transferable traffic band s of the shortest paths R1 to R4, which are held.

Thus, when a failure is caused to occur in the NW function section B2, the quality prediction section 102 calculates the throughput of the redundant configuration including the NW function section B2 to be 300 (=100+100+50+50) Mbps. The test propriety determination section 103 compares the throughput (300 Mbps) calculated by the quality prediction section 102 to the throughput measured by the network monitor section 100 and determines, based on a result of the comparison, whether or not execution of the test is to be executed.

Thus, the quality prediction section 102 in the first example predicts the service quality in accordance with the identified redundant configuration type, and therefore, highly accurate prediction considering path switching and load distribution when a failure occurs may be performed.

However, the test execution server 1 in the first example acquires and registers the redundant configuration definition information 131 and performs processing of associating the redundant configuration definition information 131 with each of the NW function sections A1, B1 to B3, C1 to C4, D1 to D3, E1, and E2 (St3 described above). Therefore, as the number of NW functions of the network 3 increases, the complexity of processing increases, and the number of procedures of processing increases.

Therefore, as described in the following example, the test execution server 1 may be configured to identify not redundant configuration forms but a configuration of the groups B to E of the NW function sections A1, B1 to B3, C1 to C4, D1 to D3, E1, and E2 to which a load is distributed and predict service quality in accordance with the identified configuration of the groups B to E. In this case, processing of acquisition and registration of the redundant configuration definition information 131 and association of the redundant configuration definition information 131 with each of the NW function sections A1, B1 to B3, C1 to C4, D1 to D3, E1, and E2 is omitted, so that the processing is simplified and the number of procedures of processing is reduced.

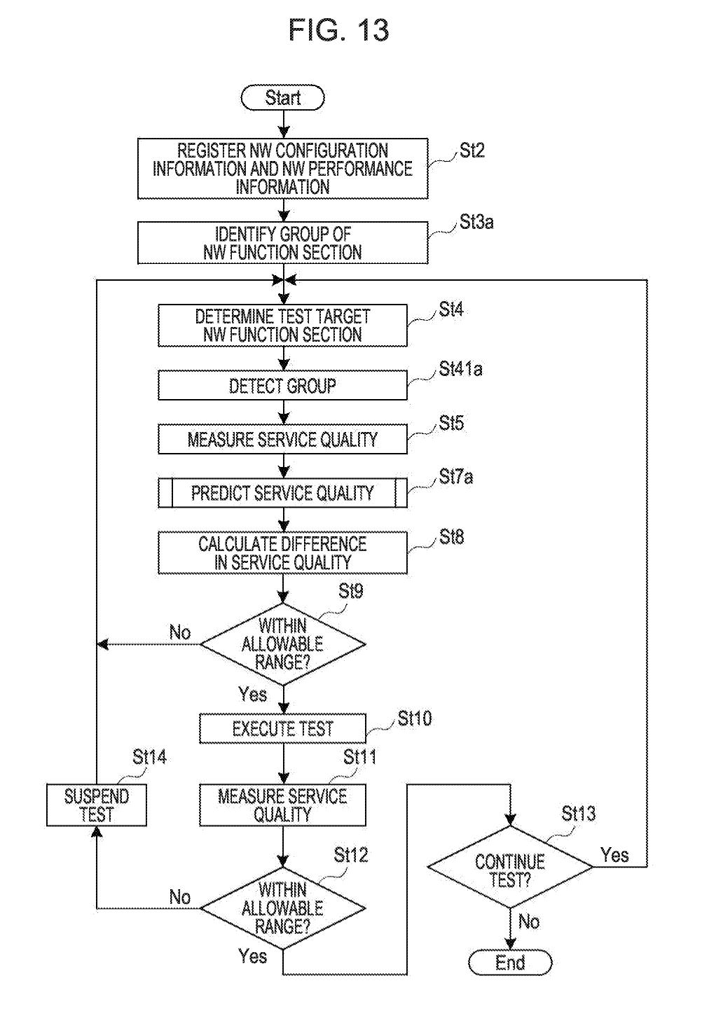

FIG. 13 is a flowchart illustrating a second example of processing performed by the test execution server 1 of this example. In FIG. 13, each operation in common with FIG. 4 is denoted by the same reference numeral and the description thereof will be omitted.

First, the network information acquisition section 105 acquires and registers the network configuration information 130 and the network performance information 132 (St2). Next, the quality prediction section 102 refers to the network configuration information 130 and identifies configurations of the respective groups B to E of the NW function sections A1, B1 to B3, C1 to C4, D1 to D3, E1, and E2 on which load distribution processing is performed (St3a). The quality prediction section 102 identifies, for example, that processing is distributed between the NW function sections B1 to B3 of the group B and that the processing is distributed between the NW function sections C1 to C4 of the group C.

Next, the test target determination section 101 determines a test target NW function section out of the NW function sections A1, B1 to B3, C1 to C4, D1 to D3, E1, and E2 (St4). Next, the quality prediction section 102 detects a group among the groups B to E, which corresponds to the test target NW function out of the NW function sections A1, B1 to B3, C1 to C4, D1 to D3, E1, and E2 (St41a). For example, when it is determined that the NW function section C1 is a test target, the quality prediction section 102 detects the group C of the NW function section C1.

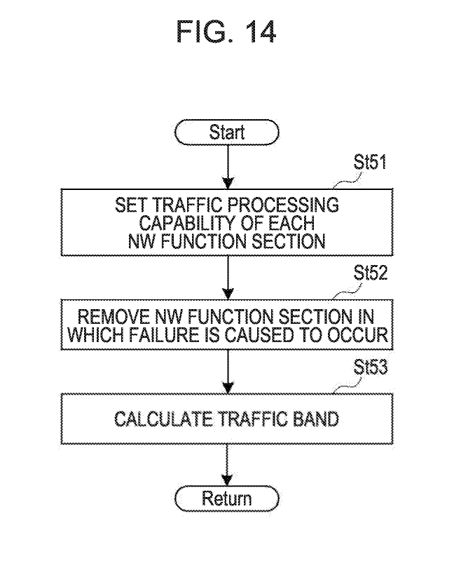

Next, the quality prediction section 102 predicts the service quality during a test on the network 3 that is in operation (St7a). This processing will be described with reference to FIG. 14. St8 and the subsequent processing are as described above with reference to FIG. 4.

FIG. 14 is a flowchart illustrating a second example of service quality prediction processing. This processing is executed in St7a described above.

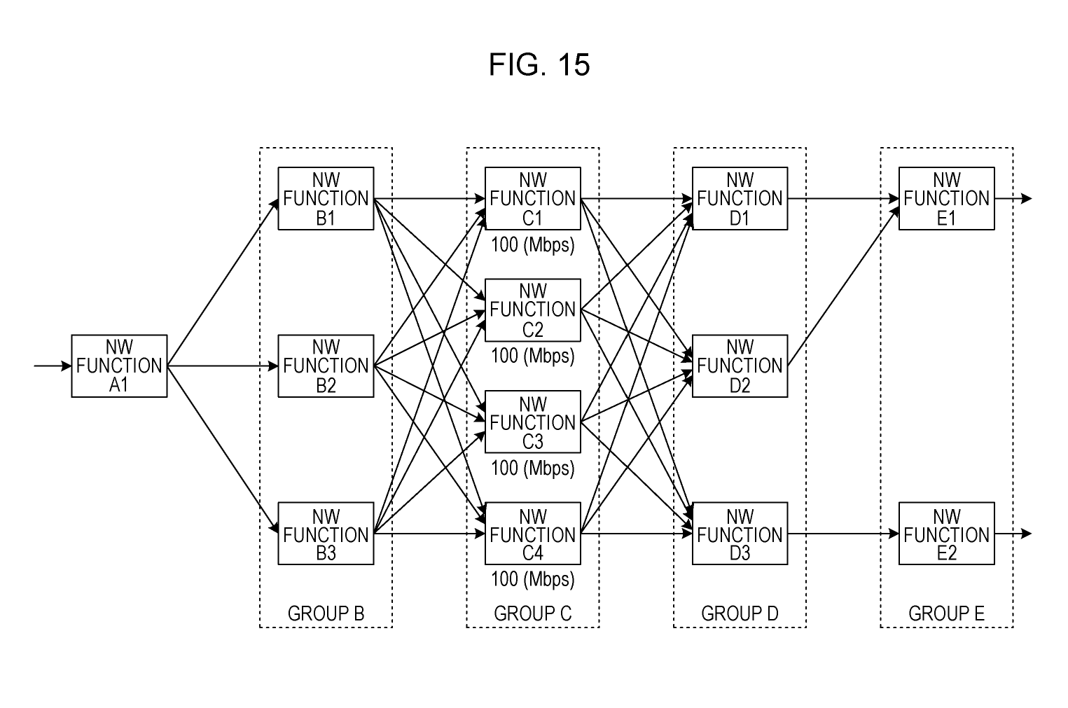

The quality prediction section 102 sets traffic processing capability based on the network performance information 132 for each of the NW function sections C1 to C4 of the group C detected in St41a (St51). The quality prediction section 102, for example, sets the maximum transferable traffic band for transferring the traffic Tr for the respective NW function sections C1 to C4. An example of the maximum transferable traffic band for the respective NW function sections C1 to C4 is illustrated in FIG. 15.

Next, the quality prediction section 102 removes the NW function section C1 in which a failure is caused to occur from the NW function sections C1 to C4 of the group C (St52). Next, the quality prediction section 102 calculates the transferable traffic bands of the respective groups B to E (St53).

In FIG. 15, an example of a method for calculating the transferable traffic band is illustrated. In this example, a method for calculating the transferable traffic band of the group C is described. The transferable traffic band of the NW function sections C2 to C4 is calculated to be 300 (=100+100+100) Mbps. The transferable traffic band is calculated for each of the other groups B, D, and E in a similar manner. Then, based on the transferable traffic band calculated for each of the groups B to E, whether or not the test is to be executed (St9 described above) is determined. The service quality prediction processing is performed in this manner.

In the second example, processing of acquisition and registration of the redundant configuration definition information 131 and association of the redundant configuration definition information 131 with each of the NW function sections A1, B1 to B3, C1 to C4, D1 to D3, E1, and E2 is omitted, so that the processing is simplified and the number of procedures of processing is reduced.

As described above, the test execution server 1 according to the embodiment includes the quality prediction section 102, the test propriety determination section 103, and the test execution section 104. The quality prediction section 102 predicts the quality of a communication service provided by the network 3 during a test on the network 3 that is in operation.

The test propriety determination section 103 determines, based on the quality predicted by the quality prediction section 102, whether or not the test is to be executed. The test execution section 104 executes the test on the network 3 in accordance with a result of the determination of the test propriety determination section 103.

In the above-described configuration, the quality prediction section 102 predicts the quality of a communication service provided by the network 3 during a test on the network 3 that is in operation, and the test propriety determination section 103 determines, based on the quality predicted by the quality prediction section 102, whether or not the test is to be executed. The test execution section 104 executes the test on the network 3 in accordance with a result of the determination of the test propriety determination section 103, and thus, may execute a test or cancel the test before the test is started depending on the influence of the test on the communication service that is being provided on the network 3. Therefore, the influence of the test of the network 3 that is in operation on the service quality may be reduced.

The network system according to the embodiment includes the test execution server 1 coupled to the network 3 that is in operation and the test execution server 1 is configured to execute a test on virtual NW function sections A1, B1 to B3, C1 to C4, D1 to D3, E1, and E2 that process a communication service provided by the network 3 and the network 3.

The test execution server 1 according to the embodiment includes the quality prediction section 102, the test propriety determination section 103, and the test execution section 104. The quality prediction section 102 predicts the quality of a communication service provided by the network 3 during a test on the network 3 that is in operation.

The test propriety determination section 103 determines, based on the quality predicted by the quality prediction section 102, whether or not the test is to be executed. The test execution section 104 executes the test on the network 3 in accordance with a result of the determination of the test propriety determination section 103.

The network system according to the embodiment has a similar configuration to that of the above-described test execution server 1, and therefore, similar advantages to those described above may be achieved.

The test method according to the embodiment includes the following operations of:

(1) predicting the quality of a communication service provide by the network 3 during a test on the network 3 that is in operation;

(2) determining, based on the predicted quality, whether or not the test is to be executed; and

(3) executing the test on the network 3 depending on a result of the determination.

The test method according to the embodiment includes a similar configuration to that of the above-described test execution server 1, and therefore, similar advantages to those described above may be achieved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A test device, comprising:
a memory; and
a processor coupled to the memory and the processor configured to
perform a simulation of a first test to be executed on a network that is in operation,
acquire a first quality, the first quality being a quality of a communication service provided by the network when the simulation is performed,
determine, on basis of the first quality, whether to execute the first test, and
execute the first test on the network depending on a result of the determination.

2. The test device according to claim 1, wherein
the processor is configured to cause a first failure to occur in the network when executing the first test,
acquire, as the first quality, a quality of the communication service when the first failure occurs in the network, and
determine, on basis of the first quality, whether to cause the first failure to occur in the network.

3. The test device according to claim 1, wherein
the processor is configured to
input first traffic to the network when executing the first test,
acquire, as the first quality, a quality of the communication service when the first traffic is input to the network, and
determine, on basis of the first quality, whether to input the first traffic to the network.

4. The test device according to claim 1, wherein
the processor is configured to
measure a second quality, the second quality being a quality of the communication service when the first test is not executed,
compare the first quality and the second quality to each other, and
determine, on basis of a result of the comparison, whether to execute the first test.

5. The test device according to claim 1, wherein
the network includes a plurality of physical or virtual communication devices for processing the communication service, and
the processor is configured to
identify a redundant configuration between the plurality of communication devices, and
acquire the first quality on basis of the identified redundant configuration.

6. The test device according to claim 1, wherein
the network includes a plurality of physical or virtual communication devices for processing the communication service, and
the processor is configured to
identify a group of communication devices among the plurality of communication devices, on which processing loads are distributed, and
acquire the first quality on basis of a configuration of the identified group.

7. A network system, comprising:
a server device including:
a first processor configured to
form a network including a plurality of virtual communication devices; and
a test device including:
a second processor configured to
perform a simulation of a first test to be executed on the network that is in operation,
acquire a first quality, the first quality being a quality of a communication service provided by the network when the simulation is performed,
determine, on basis of the first quality, whether to execute the first test, and
execute the first test on the network depending on a result of the determination.

8. The network system according to claim 7, wherein
the second processor is configured to
cause a first failure to occur in the network when executing the first test,
acquire, as the first quality, a quality of the communication service when the first failure occurs in the network, and
determine, on basis of the first quality, whether to cause the first failure to occur in the network.

9. The network system according to claim 7, wherein
the second processor is configured to
input first traffic to the network when executing the first test,
acquire, as the first quality, a quality of the communication service when the first traffic is input to the network, and
determine, on basis of the first quality, whether to input the first traffic to the network.

10. The network system according to claim 7, wherein
the second processor is configured to
measure a second quality, the second quality being a quality of the communication service when the first test is not executed,
compare the first quality and the second quality to each other, and
determine, on basis of a result of the comparison, whether to execute the first test.

11. A test method, comprising:
performing, by a computer, a simulation of a first test to be executed on a network that is in operation;
acquiring a first quality, the first quality being a quality of a communication service provided by the network when the simulation is performed;
determining, on basis of the first quality, whether to execute the first test; and
executing the first test on the network depending on a result of the determination.

12. The test method according to claim 11, further comprising:
causing a first failure to occur in the network when executing the first test;
acquiring, as the first quality, a quality of the communication service when the first failure occurs in the network; and
determining, on basis of the first quality, whether to cause the first failure to occur in the network.

13. The test method according to claim 11, further comprising:
inputting first traffic to the network when executing the first test;
acquiring, as the first quality, a quality of the communication service when the first traffic is input to the network; and
determining, on basis of the first quality, whether to input the first traffic to the network.

14. The test method according to claim 11, further comprising:
measuring a second quality, the second quality being a quality of the communication service when the first test is not executed;
comparing the first quality and the second quality to each other; and
determining, on basis of a result of the comparison, whether to execute the first test.
